(19) United States
(12) Patent Application Publication
(10) Pub. No.: US 2026/0140953 A1
(43) Pub. Date: May 21, 2026

(54) RESOURCE-EFFICIENT MAINTENANCE OF DATABASE INDEXES

(71) Applicant: SAP SE, Walldorf (DE)

(72) Inventor: Hui Li, Shanghai (CN)

(21) Appl. No.: 18/949,916

(22) Filed: Nov. 15, 2024

(51) Int. Cl. G06F 16/2455; G06F 16/22

(52) U.S. Cl. CPC G06F 16/24553; G06F 16/221

(57) ABSTRACT

Methods, systems, and computer-readable storage media for receiving first metrics representative of execution of a first query within the database system, the first query being in a set of queries executed by a tenant within the database system, determining, responsive to the first metrics, that the first query is to be processed for indexing of one or more columns, providing a set of columns for the first query, and for each column in the set of columns, selectively updating a table index of the tenant within the database system to include an index on the column at least partially in response to a function on the column within the query and a data type of the column.

### BACKGROUND

Database systems organize data that is stored in a database. Transactions can be executed on the data to, for example, read data from and/or write data to the database. In many cases, the database system is executed by a host, which includes a computing device in, for example, a cloud computing environment. Within a database system, data is stored in tables as records, and indexes are provided to enable rapid retrieval of data. The tables are stored in data pages that are stored in computer-readable/-writable memory.

In many scenarios, database systems are accessed by multiple, disparate tenants, each tenant having different database schemas. Despite the different schemas or business logic used, multiple tenants can access the same data structure. As an example, one or more tables stored in the database system can be accessed by a group of tenants, but those different tenants can query a particular table according to respective tenant-specific logic. In response to the queries, a table index for the table can be created, the table index being generalized to all tenants. However, the table index will include indexes on columns, or other portions of a common data structure, that are irrelevant to some tenants. Consequently, technical resources, such as processing and memory, are wasted in the creation and maintenance of table indexes having indexes on columns that are not relevant to all tenants.

### SUMMARY

Implementations of the present disclosure are directed to resource-efficient maintenance of table indexes in database systems. More particularly, implementations of the present disclosure are directed to automatic generation and updating of tenant-specific indexes on tables of database systems in cloud computing environments.

In some implementations, actions include receiving first metrics representative of execution of a first query within the database system, the first query being in a set of queries executed by a tenant within the database system, determining, responsive to the first metrics, that the first query is to be processed for indexing of one or more columns, providing a set of columns for the first query, and for each column in the set of columns, selectively updating a table index of the tenant within the database system to include an index on the column at least partially in response to a function on the column within the query and a data type of the column. Other implementations of this aspect include corresponding systems, apparatus, and computer programs, configured to perform the actions of the methods, encoded on computer storage devices.

These and other implementations can each optionally include one or more of the following features: selectively updating the table index of the tenant within the database system to include an index on the column is further in response to determining that the column is indexable using a list of columns; determining, responsive to the first metrics, that the first query is to be processed for indexing of one or more columns includes determining that the query has been executed at least a threshold number of times in a time window, and determining that time cost of the query exceeds a threshold time cost; the table index is initialized within the database system to include indexes on columns common to all tenants of the database system; actions further include receiving usage metrics for a column having an index on the column for the tenant, and selectively deleting the index on the column responsive to the usage metrics; the index on the column is deleted in response to the usage metrics indicating that the index on the column has not been used at least a threshold number of times within a time window; and actions further include receiving second metrics representative of execution of a second query within the database system, the second query being in the set of queries executed by the tenant within the database system, and determining, responsive to the second metrics, that the second query is not to be processed for indexing of one or more columns.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts an example process that can be executed in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to resource-efficient maintenance of table indexes in database systems. More particularly, implementations of the present disclosure are directed to automatic generation and updating of tenant-specific indexes on tables of database systems in cloud computing environments. Implementations can include actions of receiving first metrics representative of execution of a first query within the database system, the first query being in a set of queries executed by a tenant within the database system, determining, responsive to the first metrics, that the first query is to be processed for indexing of one or more columns, providing a set of columns for the first query, and for each column in the set of columns, selectively updating a table index of the tenant within the database system to include an index on the column at least partially in response to a function on the column within the query and a data type of the column.

Implementations of the present disclosure are described in further detail herein with reference to example systems. The example systems are provided by SAP SE of Walldorf, Germany. An example system includes SAP Adaptive Server Enterprise (ASE), which can be described as a relational database management server that provides a structured query language (SQL) database and supports online transaction processing (OLTP). It is contemplated, however, that implementations of the present disclosure can be realized with any appropriate systems and are not limited to the systems specifically referenced herein.

To provide further context for implementations of the present disclosure, and as introduced above, database systems organize data that is stored in a database. Transactions can be executed on the data to, for example, read data from and/or write data to the database. In many cases, the database system is executed by a host, which includes a computing device in, for example, a cloud computing environment.

In some implementations, a database system stores data in tables as records. In some examples, tables are stored as data pages in memory. Example records can include records representative of people (e.g., a record including fields of name, address, telephone number, email address). Database systems use one or more indexes for efficient retrieval of data from tables. An index can be described as a sorted copy of selected database table fields (columns). In some examples, index entries are stored as rows in index pages, where the index entries record key values and pointers to lower levels of the index, such as leaf pages, to the data pages, or to individual data rows. In this way, the index can provide a more direct access to one or more records or other piece of data in a table without the need for executing complex table-based operations.

In further detail, each table has a primary key that can be used to uniquely identify records within a table, where the primary keys are stored in a primary index. In the example of records representative of people, a primary key can be used to uniquely identify a person within the table (e.g., using the field of email address as the primary key). The primary key can be used to quickly find a record. In some instances, data can be retrieved from a table using a secondary index (e.g., using the field of name as a secondary key). In this manner, queries on data can be efficiently executed (e.g., find email address for all people with last name Smith). In short, indexes are used by the database system to provide fast and computationally efficient access to data and to ensure constraints are observed.

In cloud computing environments, database systems are accessed by multiple, disparate tenants, each tenant having a database schema that is specific to the tenantₙ Here, a database schema defines how data is to be stored within the database system for a respective tenantₙ However, and although different, the database schemas of multiple tenants can incorporate tables or other data structures that are accessible by all tenants. A data structure or structure is a particular format for organizing data so that processing, retrieving and storing of the data therein follows a set of operations and logical steps. It should be noted that tables are predominately used as examples in this disclosure, other types of data structures such linked lists, arrays, etc. would benefit from the teachings of this document based on the efficiencies gained by proper index management.

As introduced above, table indexes can be created to improve computational efficiency in processing queries. In general, table indexes are constructed in response to queries. In some cases, multiple tenants query tables with the same table structure. That is, for each tenant, a table is provided that, at least initially, includes the same table structure as the tables of other tenants. For each table, a table index can be created. At creation, the table index is generalized to all tenants that query the table. However, different tenants can query a table according to respective tenant-specific logic. That is, different tenants can query the table using different queries. As a result, and upon creation, the table index for the table will include indexes on columns that are irrelevant to some tenants. Consequently, technical resources, such as processing and memory, are wasted in the creation and maintenance of table indexes having indexes on columns that are not relevant to all tenants.

To illustrate this, reference can be made to a non-limiting example that includes a first tenant (tenant1) having a first database schema (SCHEMA_TENANT1) and a second tenant (tenant2) having a second database schema (SCHEMA_TENANT2). Both the first database schema and the second database schema incorporate a table (EXAM_TABLE). Here, the table (EXAM_TABLE) is the same for (common to) both the first tenant and the second tenantₙ That is, a first table (EXAM_TABLE) is provided for the first tenant, and a second table (EXAM_TABLE) is provided fir the second tenantₙ Also, a table index is created and is initially the same for both the first tenant and the second tenantₙ As noted above, different tenants can query a table according to respective tenant-specific logic. For example, to query records of the first table (EXAM_TABLE), the first tenant uses the following example SQL query:

$$SELECT * FROM SCHEMA\_TENANT1 . EXAM\_TABLE WHERE \\ COLUM 1 > ? AND COLUM 2 = ? ORDER BY COLUM 3 LIMIT \text{?} OFFSET \text{?}$$

To query records of the second table (EXAM_TABLE), the second tenant uses the following example SQL query:

$$SELECT * FROM SCHEMA\_TENANT2 . EXAM\_TABLE WHERE \\ COLUM 4 > ? AND COLUM 5 = ? ORDER BY COLUM 6 LIMIT ? OFFSET ?$$

In using the same table structure for both the first tenant and the second tenant, indexes on the columns COLUM1, COLUM2, COLUM3, COLUM4, COLUM5, and COLUM6 of the table (EXAM_TABLE) need to be created. However, the indexes on COLUM4, COLUM5, and COLUM6 are useless for the first tenant and the indexes on COLUM1, COLUM2, and COLUM3 are useless for the second tenantₙ As a consequence, and if considered across tens, hundreds, if not thousands of tenants, a significant amount of technical resources (e.g., processors, memory) are expended to create and maintain indexes on columns that are useless for other tenants. Also, these useless indexes can downgrade the performance of insert/edit/delete operations on the table.

In view of the above context, implementations of the present disclosure provide for resource-efficient creation and maintenance of table indexes in database systems. More particularly, implementations of the present disclosure provide for automatic creation and maintenance of table indexes for tenants of a database system in cloud computing environments. In some implementations, and as described in further detail herein, implementations of the present disclosure include, for each tenant, initializing common indexes, analyzing query executions and creating indexes, and removing useless indexes for the respective tenant.

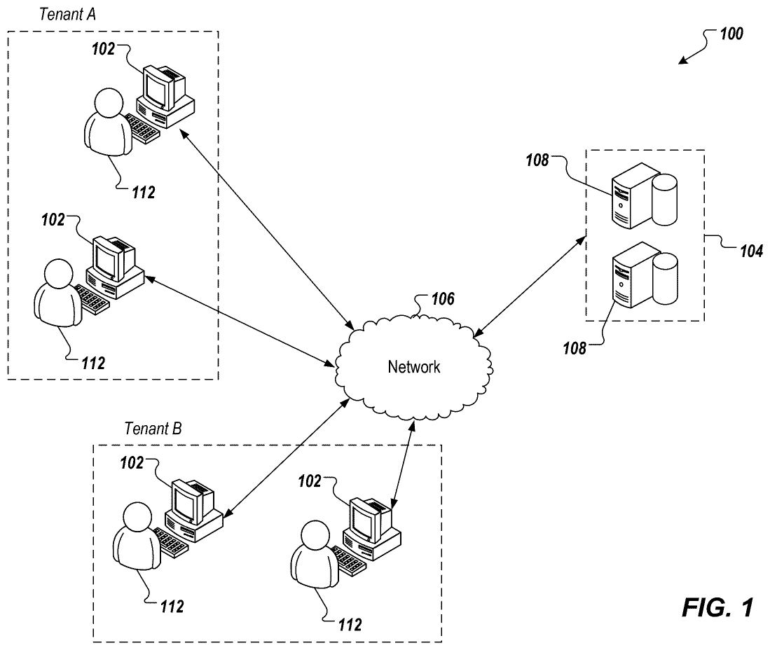

FIG. 1 depicts an example architecture 100 in accordance with implementations of the present disclosure. In the depicted example, the example architecture 100 includes client devices 102, a network 106, and a server system 104. The server system 104 includes one or more server devices and databases 108 (e.g., processors, memory). In the depicted example, users 112 interact with client devices 102. The example of FIG. 1 represents a multi-tenant scenario including a Tenant A and a Tenant B. For example, each tenant can represent a respective enterprise and users 112 can represent agents (e.g., employees) of the enterprise. As such, varying numbers of tenants can be provided, each tenant having a varying number of users.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client devices 102 over the network 106).

In some implementations, the server system 104 can host a database system. For example, the server system 104 can host a relational database management server that provides a SQL database for OLTP transactions, such as in the example context of SAP ASE. In accordance with implementations of the present disclosure, processes can be executed within the server system 104 for automatic creation and maintenance of table indexes for tenants of a database system in cloud computing environments, as described in further detail herein. In some implementations, and as described in further detail herein, implementations of the present disclosure include, for each tenant, initializing common indexes, analyzing query execution and creating indexes, and removing useless indexes.

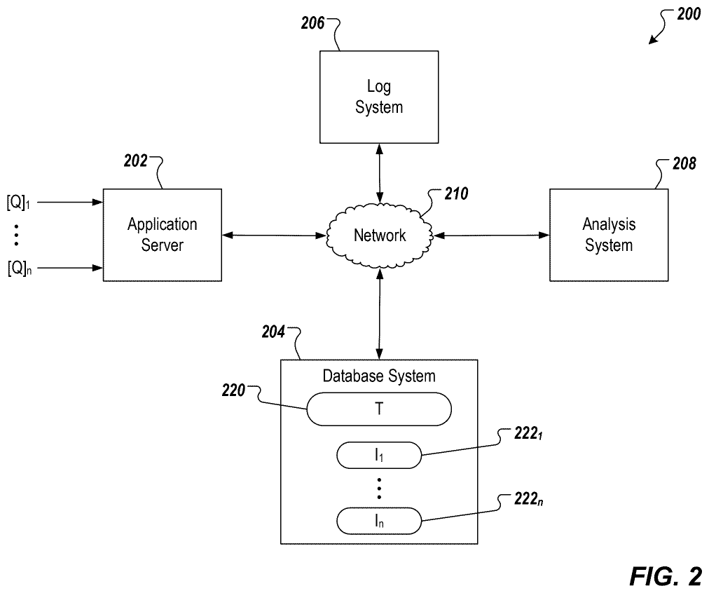

FIG. 2 depicts an example conceptual architecture 200 in accordance with implementations of the present disclosure. In the example of FIG. 2, the example conceptual architecture 200 includes an application server 202, a database system 204, a log system 206, an analysis system 208, and a network 210. In some examples, components of the example conceptual architecture 200 communicate over the network 210 (e.g., LAN, WAN, Internet, etc.). While application server 202, database 204, log system 206 and analysis system 208 are shown as discrete elements, any combination of these sub-systems can be combined in other implementations.

In some implementations, the application server 202 executes one or more applications that provide functionality for multiple tenants, such as tenant₁, . . . , tenantₙ. For example, the application server 202 enables the tenants to submit queries (e.g., a set of queries [Q]₁ for tenant₁, . . . a set of queries [Q]ₙ for tenantₙ) to the database system 204, which returns responses to the queries. In some examples, a query is used to query one or more tables that are maintained within the database system 204. In the example of FIG. 2, the database system 204 maintains a table (T) 220. Table (T) 220 stores any type of tenant data such as employee records, sales records, customer records, etc. Although a single table is represented in the example of FIG. 2, it is contemplated that the database system 204 can maintain any appropriate number of tables. Each of the tenants (e.g., tenant₁, . . . , tenantₙ) has a respective database schema within the database system 204 that is disparate from database schemas of other tenants, each database schema including the table 220. As described in further detail herein, implementations of the present disclosure enable resource-efficient maintenance of table indexes 222₁, . . . , 222ₙ for each of the tenants. It should be noted that the table indexes 222₁, . . . , 222ₙ are shown as discrete elements, but any combination of such table indexes could be grouped together as long as restrictions are applied such that each tenant₁, . . . , tenantₙ has access to its associated table indexes 222₁, . . . , 222ₙ and corresponding data stored in table (T) 220. It should also be noted that while table (T) 220 is common to multiple tenants, various techniques can be applied to maintain data privacy such as restricting sets of rows to each tenant, using a tenant key to associate select rows with their respective tenant and various forms of cryptography.

In accordance with implementations of the present disclosure, for each tenant, a table index 222₁, . . . , 222ₙ is initialized. In some examples, initialization of the table indexes 222₁, . . . , 222ₙ occurs prior to a respective tenant querying the database system 204. In some examples, after initialization, the table indexes 222₁, . . . , 222ₙ include indexes on a set of columns that represents columns of the table 220 expected to be queried by all tenants. Accordingly, the following example table indexes 222_{1 . . . n} can be provided:

$${table\_index}_{1} \to [ C 1 , C 3 , C 5 ] \\ … \\ {table\_index}_{n} \to [ C 1 , C 3 , C 5 ]$$

where C1, C3, and C5 are columns expected to be queried by all n tenants. As such, at an initial time (t₀), the table indexes 222₁, . . . , 222ₙ of the multiple tenants are the same.

In some implementations, tenants submit queries to the database system 204 (e.g., the sets of queries [Q]₁, . . . , [Q]ₙ) and the table indexes 222₁, . . . , 222ₙ of the respective tenants are used for processing of the queries. Further, metrics for the queries are recorded in the log system 206. In some examples, metrics can include a set of costs, such as, but not limited to, time cost (time to execute a query), processing cost (processing consumed to execute the query), memory cost (memory consumed in executing the query), and bandwidth cost (network I/O consumed in executing the query). Accordingly, for each query submitted by a tenant to the database system, the log system 206 stores metrics representative of execution of the query. In some examples, a query can be executed multiple times and, for each execution, a set of metrics is stored.

In some implementations, the analysis system 208 processes metrics of the queries to determine whether table indexes of respective tenants are to be updated. In some examples, for each tenant and each query, an execution count (C_{EX}) for a time window (t_{WIN}) (e.g., 24 hours, 48 hours, 72 hours, week, month) is determined. Here, the execution count (C_{EX}) represents a number of times the query was executed for the tenant within the time window (t_{WIN}). The execution count (C_{EX}) is compared to a threshold execution count (T_{EX}) to determine whether further processing is to be performed. In some examples, the log system 206 monitors the execution count (C_{EX}) and makes the determination. In some examples, the analysis system 208 receives the execution count (C_{EX}) from the log system 206 and makes the determination.

In some examples, if the execution count (C_{EX}) exceeds the threshold execution count (T_{EX}) in the time window (t_{WIN}), the analysis system 208 further processes the metrics of the query. For example, the analysis system 208 receives metrics data for the query from the log system 206. In some examples, values of metrics can be aggregated across the multiple executions. Example aggregations can include, without limitation, averaging, minimum, and maximum. By way of non-limiting example, multiple time costs can be provided, each time cost corresponding to a respective execution of a query. In aggregation, an average time cost can be determined and used for analysis, or a maximum time cost of the multiple time costs can be determined and used for analysis.

In some examples, the analysis system 208 compares the aggregate time cost (t_{CA}) to a threshold aggregate cost (T_{CA}). If the aggregate time cost (t_{CA}) exceeds the threshold aggregate cost (T_{CA}), it is determined that the query is a query that is executing too slowly and is to be further processed for potential updating of the table index for the tenant who generated the query. In some examples, further processing includes parsing the query to provide a set of sub-queries and, for each sub-query, determining a set of clauses.

For example, a SQL query, which is text, can be parsed using a SQL parser, which parses the text into a structured data structure (as only one example, an abstract syntax tree (AST)) that contains the details of the queries JOIN ON, WHERE, ORDER BY, GROUP BY, and HAVING sub-statements. The clauses in the set of clauses are compared to a list of clauses. Example clauses in the list of clauses can include JOIN ON, WHERE, ORDER BY, GROUP BY, and HAVING. If one or more clauses in the set of clauses is included in the list of clauses, a list of predicate columns associated with the one or more clauses is provided. In some examples, a predicate column can be described as a column of a table that corresponds to a predicate of the query. In some examples, a predicate can be described as a field that is used to filter and/or manipulate data by, for example, enabling a query to select, update, and/or delete data based on certain criteria in execution of clauses. Here, a set of columns (e.g., [C₁, . . . , Cₖ]) can be provided, which includes columns that are to be further processed for potential updating of the table indexes 222_{1 . . . n} for the tenant.

In some implementations, for each column in the set of columns, it is determined whether the column can be included in a table index. If the column can be included in a table index, it is included in a sub-set of columns. In some examples, a column list can be provided that indicates columns that can be indexed (are allowed to be indexed) for tenants. In some examples, the column list can be a positive list indicating columns that can be indexed for tenants. In the case of a positive list, each column is compared to the column list and, if the column is included in the column list, the column can be included in a table index. If the column is not included in the column list, the column cannot be included in a table index. In some examples, the column list can be a negative list indicating columns that cannot be indexed for tenants.

In some examples, whether a column can be included in a table index can be determined by a development team during a design time. In some examples, columns with poor uniqueness are not included, because such columns represent few distinct values and poor selectivity, because the effect of the table index would be minimal and the maintenance overhead would outweigh the benefits. In some examples, columns with relatively small value ranges are not included, because indexing on such values would not measurably improve query performance. In some examples, columns with frequent updates are not included, because every update operation would require the index to be rebuilt or adjusted, significantly increasing the write operation burden and potentially degrading overall performance. In some examples, columns having relatively large text fields are not included, because this would result in excessively large index files, consuming substantial storage space and increasing I/O overhead during queries, ultimately reducing query efficiency.

If a column can be included in a table index, the analysis system 208 determines whether the column is already included in the associated table index 222₁, . . . 222ₙ for the tenantₙ If a column is already included in the associated table index 222₁, . . . 222ₙ, the table index 222₁, . . . , 222ₙ associated with the tenant that generated the query need not be updated for that column. If a column is not already included in the table index 222₁, . . . , 222ₙ for that tenant, further processing to consider the column for updating the table index 222₁, . . . , 222ₙ is performed. If a column is not already included in the associated table index 222₁, . . . , 222ₙ, the analysis system 108 determines whether the query performs a function on the column. Example functions can include, but are not limited to aggregate functions (e.g., COUNT, SUM, AVG, MIN, MAX) and scalar functions (e.g., UPPER, LOWER, ROUND, NOW). If a function is performed on the column, the column cannot be included in the associated table index 222₁, . . . , 222ₙ. For example, columns involved in computations within query conditions are not included, because indexes are built on the raw values of columns, not their computed results.

If no function is performed on the column, the column can be included in the associated table index 222₁, . . . , 222ₙ, and the analysis system 208 determines whether a data type of the column is included in a list of data types. For example, and as discussed herein, each column represents a field and corresponds to a type of data. Example types of data can include string data types (e.g., CHAR, VARCHAR, SHORT CHAR, SHORT VARCHAR BINARY, VARBINARY, etc.), numerical data types (e.g., INTEGER, BOOLEAN, DECIMAL, etc.), and date/time data types. In some examples, the list of data types includes NUMBER, SHORT CHAR, and SHORT VARCHAR.

In general, data types that are not suitable for indexing include BLOB, CLOB, TEXT and other large objects, for various reasons. For example, such data types data types store significant amounts of text or binary data, such as articles, images, or videos. The sheer volume of data makes their storage and retrieval inherently slow, involving significant disk I/O operations. Indexing such data types may not significantly improve retrieval speed due to the large data size. As another example, indexes themselves consume storage space. For large objects, creating indexes would lead to a substantial increase in storage requirements, raising the cost of maintaining the database. As another example, many database systems do not directly support indexing large object data types, or if supported, the indexing mechanisms may be inefficient. The unique physical storage of these data types can make them challenging to index effectively. As still another example, when the data in large object types changes (e.g., insertions, updates, deletions), maintaining the indexes can be costly due to the significant data volumes involved. This can negatively impact the write performance of the database. As yet another example, queries involving large object data types often require full table scans or complex subqueries, which inherently slow down performance. Even if indexes were created, the performance gains might be minimal due to the limitations of indexing large data.

In some examples, if the data type of the column is included in the list of data types, an index is created on the column in the table index 222_{1 . . . n}. In some examples, an index for a column can be created by a data definition language (DDL). For example, an index on the column C1 of table T1 of schema SCHEMA_TENANT1 can be created by the DDL as follows:

$$CREATE INDEX idx\_c 1 \_on \_t 1 \\ ON SCHEMA\_TENANT 1. T 1 ( C 1 ) ;$$

Here, idx_cl_on_t1 is the name of the index, which is guaranteed to be unique within the same schema and associated with the tenant who generated the query.

Referring again to the example table indexes 222₁, . . . , 222ₙ above, the table indexes 222₁, . . . , 222ₙ can each be updated over time in view of the particular use by the respective tenants. For example, at a time (t₁), which is later than the initial time (t₀), updated versions of the example table indexes 222₁, . . . , 222ₙ can be provided as:

$${table\_index}_{1} \to [ C 1 , C 4 , C 5 , C 7 , C 8 ] \\ … \\ {table\_index}_{n} \to [ C 1 , C 2 , C 6 , C 10 ]$$

As such, at the time (t₁), the table indexes 222_{1 . . . n} of multiple tenants are disparate and tenant-specific.

Implementations of the present disclosure can be illustrated considering non-limiting examples. In the non-limiting examples, for a period of time (e.g., t_{WEV}) and respective tenants, queries having an execution count that exceeds a count threshold and an aggregate time cost that exceeds a time threshold are processed. As described herein, processing includes parsing the queries to identify predicate columns at particular clauses (e.g., JOIN ON, WHERE, ORDER BY, GROUP BY, HAVING). It is determined whether the table index for the tenant already includes indexes on the predicate columns that have been identified. It is also determined whether the particular clauses of the queries include functions and whether data types are NUMBER, SHORT CHAR, and SHORT VARCHAR.

For a first tenant, the following example first SQL query can be considered:

$$SELECT a . COLUMN 1 , a . COLUMN 2 , b . COLUMN 3 , b . COLUMN 4 … FROM SCHAMA\_TENANT 1. TABLE\_A a JOIN SCHAMA\_TENANT 1. TABLE\_B b ON a . COLUMN 5 = b . COLUMN 6 WHERE a . COLUMN 7 = \text{} ? AND b . COLUMN 8 > ? AND LOWER ( \text{} a . COLUMN 9 ) = \text{} ? ORDER a . COLUMN 10 LIMIT ? OFFSET$$

For the example first SQL query, it can be determined that some of the columns can be indexed (e.g., are not on the negative list, or on the positive list), and their types are NUMBER, SHORT CHAR, and SHORT VARCHAR. Table 1 illustrates analysis on whether to create indexes on the columns:

TABLE 1
Analysis Illustration for First Query

| | | Create | |
|---|---|---|---|
| Table | Column | Index | Remark |
| TABLE_A | COLUMN5 | Yes | used by JOIN ON clause without |
| | | | function |
| TABLE_B | COLUMN6 | Yes | used by JOIN ON clause without |
| | | | function |
| TABLE_A | COLUMN7 | Yes | used by WHERE clause for |
| | | | operation = without function |
| TABLE_B | COLUMN8 | Yes | used by WHERE clause for |
| | | | operation > without function |
| TABLE_A | COLUMN9 | No | used by WHERE clause but with |
| | | | function |
| TABLE_A | COLUMN10 | Yes | used by ORDER BY clause |
| | | | without function |

For a second tenant, the following example second SQL query can be considered:

$$SELECT a . COLUMN 1 , MAX ( a . COLUMN 2 ) , MIN ( b . COLUMN 3 ) , COUNT ( \text{} b . COLUMN 4 ) … FROM SCHAMA\_TENANT 1. TABLE\_A a JOIN SCHAMA\_TENANT 1. TABLE\_B b ON a . COLUMN 5 = b . COLUMN 6 WHERE a . COLUMN 7 = \text{} ? AND b . COLUMN 8 < ? AND LOWER ( a . COLUMN 9 ) = ? GROUP B Y a . COLUMN \text{1} HAVING \text{MAX} ( \text{} b . COLUMN \text{11} ) \text{> ? LIMIT ? OFFSET}$$

For the example second SQL query, it can be determined that some of the columns can be indexed (e.g., are not on the negative list, or on the positive list), and their types are number, short char, or short string. Table 2 illustrates analysis on whether to create indexes on the columns:

TABLE 2
Analysis Illustration for Second Query

| | | Create | |
|---|---|---|---|
| Table | Column | Index | Remark |
| TABLE_A | COLUMN5 | Yes | used by JOIN ON clause without |
| | | | function |
| TABLE_B | COLUMN6 | Yes | used by JOIN ON clause without |
| | | | function |
| TABLE_A | COLUMN7 | Yes | used by WHERE clause for |
| | | | operation = without function |
| TABLE_B | COLUMN8 | Yes | used by WHERE clause for |
| | | | operation < without function |
| TABLE_A | COLUMN9 | No | used by WHERE clause but with |
| | | | function |
| TABLE_A | COLUMN1 | Yes | used by GROUP BY clause |
| | | | without function |
| TABLE_B | COLUMN11 | No | used by HAVING clause but with |
| | | | function |

As introduced above, implementations of the present disclosure also include selectively removing indexes of columns from table indexes, if the indexes are determined to be useless (e.g., unused) for respective tenants. For example, and referring again to FIG. 2, the log system 206 can log usage metrics for each of the indexes 222₁, . . . , 222ₙ, an example metric including a use count that represents a number of times a particular column index is used. In some examples, if an index on a column is not used at least a threshold number of times within a time window (e.g., the time window (t_{WIN})), it is determined that the index on the column is timewise obsolete (e.g., it hasn't been accessed in a while) or otherwise not used enough to merit resources to maintain the index, and it is deleted from the corresponding index 222₁, . . . , 222ₙ of the respective tenantₙ For example, the analysis system 208 can update the associated index 222₁, . . . 222ₙ to remove the index on the column.

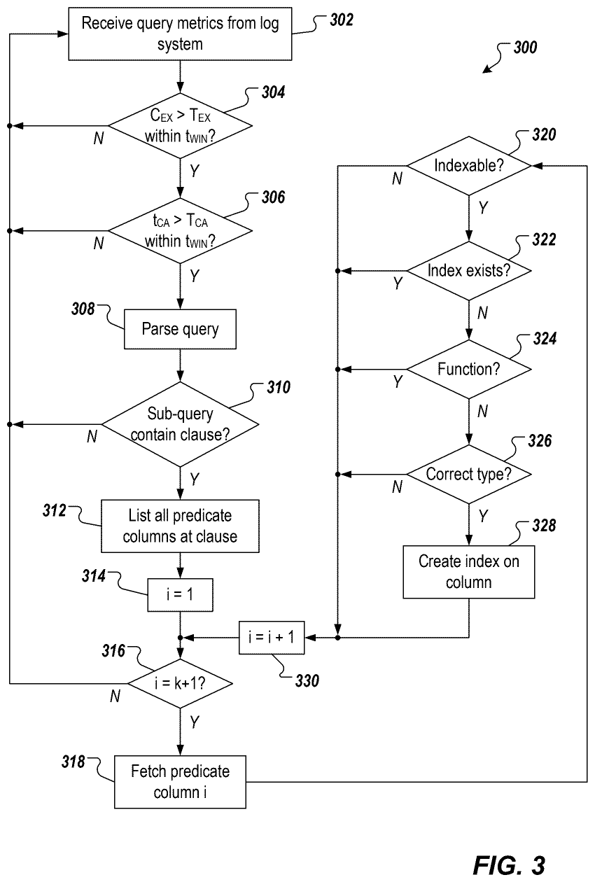

FIG. 3 depicts an example process 300 that can be executed in accordance with implementations of the present disclosure. In some examples, the example process 300 is provided using one or more computer-executable programs executed by one or more computing devices. In some examples, the example process 300 is periodically executed for each tenant that queries a database system and for individual queries that the tenant uses to query the database system.

Query metrics are retrieved from a log system (302). For example, and as described herein with reference to FIG. 2, the analysis system 208 can receive metrics from the log system 206. It is determined whether an execution count (C_{EX}) exceeds a threshold (T_{EX}) within t_{WIN} (304). If C_{EX} does not exceed T_{EX} within t_{WIN}, the example process 300 loops back (e.g., to consider another query for the tenant). If C_{EX} does exceed T_{EX} within t_{WIN}, it is determined whether an aggregate time cost (t_{CA}) exceeds a threshold aggregate cost (T_{CA}) (306). If t_{CA} exceeds T_{CA} (i.e., the query is determined to execute too slowly), the query is parsed (308). For example and as described herein, the query is parsed into a set of sub-queries. For each sub-query, clauses are compared to a list of clauses (e.g., JOIN ON, WHERE, ORDER BY, GROUP BY, HAVING) to determine a set of columns (e.g., [C₁, . . . , Cₖ]) associated with each clause, which includes columns that are to be further processed for potential updating of the table index for the tenantₙ More particularly, if it is determined that one or more clauses of the sub-query are in a set of select clauses of a in a list of clauses (310), a list of predicate columns associated with the one or more listed clauses is provided (312). This list of predicate columns can be an array from 1 to k, where k is the number of predicate columns in the query. An example set of columns can be provided as:

$${C}_{1} \to COLUMN 5 \\ {C}_{2} \to COLUMN 7 \\ {C}_{3} \to COLUMN 1 \\ where k = 3 .$$

A counter i is set equal to 1 (314) and it is determined whether the counter i is equal to k+1 (316). That is, it is determined whether all columns in the set of predicate columns of the query (e.g., [C₁, . . . , Cₖ]]) have been processed. If the counter i is equal to k+1, the example process 300 loops back (e.g., to consider another query for the tenant). If the counter i is not equal to k+1, the predicate column i in the set of columns is retrieved (318). For example, the analysis system 208 retrieves the predicate column that is listed as the i^{th} element of the list or array of predicate columns from the database system 204.

It is determined whether the column is indexable (320). For example, and as described herein, the column can be compared to a column list that indicates columns that can be indexed. If the column is indexable, it is determined whether an index on the column for this particular tenant already exists (322). For example, and as described herein, the analysis system 208 determines whether the column is already included in the table index 222_{1 . . . n} for the tenantₙ If an index on the column does not already exist, it is determined whether a function on the column is executed within the query (324). For example, and as described herein, the analysis system 108 determines whether the query performs a function on the column. Example functions can include, but are not limited to aggregate functions (e.g., COUNT, SUM, AVG, MIN, MAX) and scalar functions (e.g., UPPER, LOWER, ROUND, NOW).

If it is determined that a function is executed on the column, it is determined whether the data type of the column is of a specific data type (326). For example, and as described herein, the analysis system 208 determines whether a data type of the column is included in a list of data types. If the data type is of the listed type, an index on the column is created (328) and the counter i is incremented (330). If the column is not indexable, if an index on the column already exists, if a function is not executed on the column, or if the data type is not of the listed type, an index on the column is not created and the counter i is incremented (330).

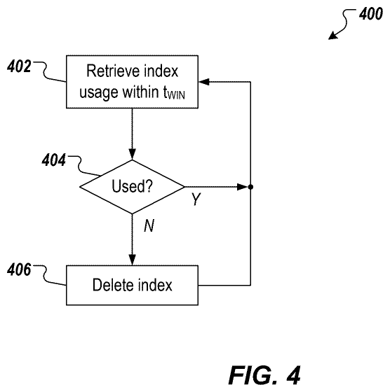

FIG. 4 depicts an example process 400 that can be executed in accordance with implementations of the present disclosure. In some examples, the example process 400 is provided using one or more computer-executable programs executed by one or more computing devices.

An index usage for an index on a column is retrieved (402). For example, and as described herein, the log system 206 can log usage metrics for each of the indexes 222_{1 . . . n}, an example metric including a use count that represents a number of times a particular column index is used. It is determined whether the index on the column has been used at least a threshold number of times (e.g., at least once) within a time window (404). If the index on the column has been used at least the threshold number of times, the example process 400 loops back (e.g., to consider an index on another column). If the index on the column has not been used at least the threshold number of times, the index on the column is deleted (406) and the example process 400 loops back.

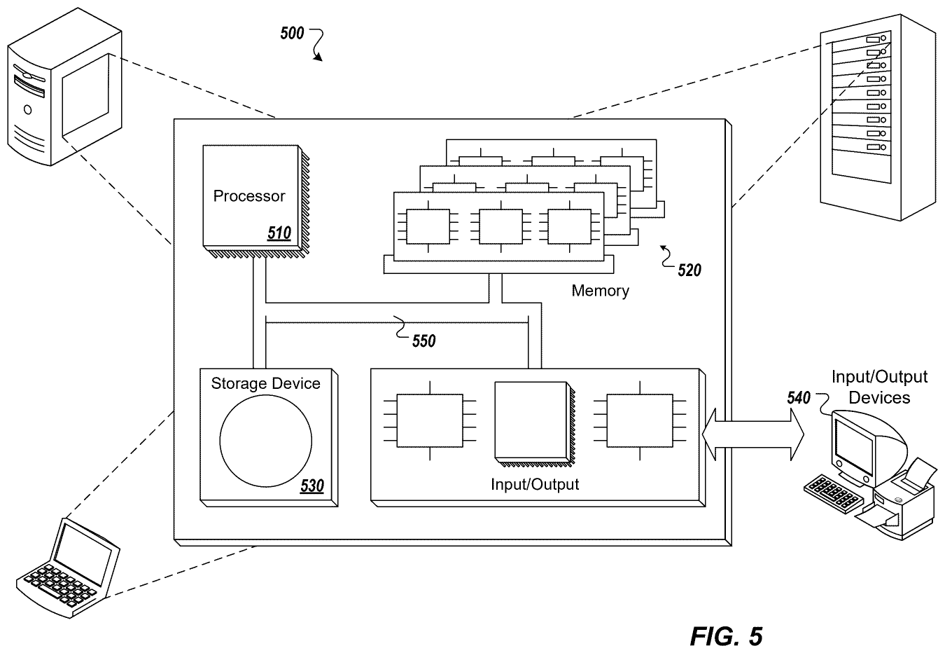

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for maintaining tenant-specific table indexes in database systems executed in cloud computing environments, the method being executed by one or more processors and comprising:
receiving first metrics representative of execution of a first query within the database system, the first query being in a set of queries executed by a tenant within the database system;
determining, responsive to the first metrics, that the first query is to be processed for indexing of one or more columns;
providing a set of columns for the first query; and
for each column in the set of columns, selectively updating a table index of the tenant within the database system to include an index on the column at least partially in response to a function on the column within the query and a data type of the column.

2. The method of claim 1, wherein selectively updating the table index of the tenant within the database system to include an index on the column is further in response to determining that the column is indexable using a list of columns.

3. The method of claim 1, wherein determining, responsive to the first metrics, that the first query is to be processed for indexing of one or more columns comprises:
determining that the query has been executed at least a threshold number of times in a time window; and
determining that time cost of the query exceeds a threshold time cost.

4. The method of claim 1, wherein the table index is initialized within the database system to include indexes on columns common to all tenants of the database system.

5. The method of claim 1, further comprising:
receiving usage metrics for a column having an index on the column for the tenant; and
selectively deleting the index on the column responsive to the usage metrics.

6. The method of claim 5, wherein the index on the column is deleted in response to the usage metrics indicating that the index on the column has not been used at least a threshold number of times within a time window.

7. The method of claim 1, further comprising:
receiving second metrics representative of execution of a second query within the database system, the second query being in the set of queries executed by the tenant within the database system; and
determining, responsive to the second metrics, that the second query is not to be processed for indexing of one or more columns.

8. A non-transitory computer-readable storage medium coupled to one or more processors and having instructions stored thereon which, when executed by the one or more processors, cause the one or more processors to perform operations for maintaining tenant-specific table indexes in database systems executed in cloud computing environments, the operations comprising:
receiving first metrics representative of execution of a first query within the database system, the first query being in a set of queries executed by a tenant within the database system;
determining, responsive to the first metrics, that the first query is to be processed for indexing of one or more columns;
providing a set of columns for the first query; and
for each column in the set of columns, selectively updating a table index of the tenant within the database system to include an index on the column at least partially in response to a function on the column within the query and a data type of the column.

9. The non-transitory computer-readable storage medium of claim 8, wherein selectively updating the table index of the tenant within the database system to include an index on the column is further in response to determining that the column is indexable using a list of columns.

10. The non-transitory computer-readable storage medium of claim 8, wherein determining, responsive to the first metrics, that the first query is to be processed for indexing of one or more columns comprises:
determining that the query has been executed at least a threshold number of times in a time window; and
determining that time cost of the query exceeds a threshold time cost.

11. The non-transitory computer-readable storage medium of claim 8, wherein the table index is initialized within the database system to include indexes on columns common to all tenants of the database system.

12. The non-transitory computer-readable storage medium of claim 8, wherein operations further comprise:
receiving usage metrics for a column having an index on the column for the tenant; and
selectively deleting the index on the column responsive to the usage metrics.

13. The non-transitory computer-readable storage medium of claim 12, wherein the index on the column is deleted in response to the usage metrics indicating that the index on the column has not been used at least a threshold number of times within a time window.

14. The non-transitory computer-readable storage medium of claim 8, wherein operations further comprise:
receiving second metrics representative of execution of a second query within the database system, the second query being in the set of queries executed by the tenant within the database system; and
determining, responsive to the second metrics, that the second query is not to be processed for indexing of one or more columns.

15. A system, comprising:
a computing device; and
a computer-readable storage device coupled to the computing device and having instructions stored thereon which, when executed by the computing device, cause the computing device to perform operations for maintaining tenant-specific table indexes in database systems executed in cloud computing environments, the operations comprising:
receiving first metrics representative of execution of a first query within the database system, the first query being in a set of queries executed by a tenant within the database system;
determining, responsive to the first metrics, that the first query is to be processed for indexing of one or more columns;
providing a set of columns for the first query; and
for each column in the set of columns, selectively updating a table index of the tenant within the database system to include an index on the column at least partially in response to a function on the column within the query and a data type of the column.

16. The system of claim 15, wherein selectively updating the table index of the tenant within the database system to include an index on the column is further in response to determining that the column is indexable using a list of columns.

17. The system of claim 15, wherein determining, responsive to the first metrics, that the first query is to be processed for indexing of one or more columns comprises:
determining that the query has been executed at least a threshold number of times in a time window; and
determining that time cost of the query exceeds a threshold time cost.

18. The system of claim 15, wherein the table index is initialized within the database system to include indexes on columns common to all tenants of the database system.

19. The system of claim 15, wherein operations further comprise:
receiving usage metrics for a column having an index on the column for the tenant; and
selectively deleting the index on the column responsive to the usage metrics.

20. The system of claim 19, wherein the index on the column is deleted in response to the usage metrics indicating that the index on the column has not been used at least a threshold number of times within a time window.
